(19) United States
(12) Patent Application Publication
(10) Pub. No.: US 2026/0187254 A1
(43) Pub. Date: Jul. 2, 2026

(54) MACHINE LEARNING MODEL SECURITY AT A PROCESSOR

(71) Applicants: ADVANCED MICRO DEVICES, INC., Santa Clara, CA (US); ATI TECHNOLOGIES ULC, MARKHAM (CA)

(72) Inventors: Kaushal Amolak Sanghai, Boxborough, MA (US); Akila Subramaniam, Austin, TX (US); Paul Blinzer, Carnation, WA (US); Kathirkamanathan Nadarajah, Markham (CA)

(21) Appl. No.: 19/005,537

(22) Filed: Dec. 30, 2024

(51) Int. Cl. G06F 21/60

(52) U.S. Cl. CPC G06F 21/602

(57) ABSTRACT

A processor protects a machine learning model (MLM) from unauthorized access. The processor employs a neural processing unit (NPU) to execute the MLM and implements decryption and encryption processes to decrypt the MLM and re-encrypt the MLM at different points along MLM storage and execution paths. Furthermore, the processor executes the encryption and decryption processes at different processing units and processing engines, thereby reducing the ability of malicious software to access the MLM. In addition, the processor protects buffers of the NPU from unauthorized access.

### BACKGROUND

Processing systems, and associated devices) increasingly employ machine learning models (MLMs) in a wide variety of applications. For example, some processing systems employ an MLM to implement portions of a video game, to enhance images, to support features of productivity software, to implement a virtual assistant, or any combination thereof. However, conventional processing systems do not support security for the MLM, such as security features that protect access to the MLM itself. In some cases, this deficiency increases the vulnerability of the processing system as a whole. For example, some processing systems are configured to present digital content, such as entertainment content, to a user. These processing systems are employed to receive one or more streams of digital content from a wide-area network, such as the Internet, and present that content to the user. The processing systems employ an MLM to enhance the presentation of the digital content, and to otherwise improve the user experience with the processing system. In many cases, the digital content is owned by a content provider, rather than the user, and the content provider implements a digital rights management (DRM) scheme to protect the digital content from unauthorized copying, storage, or other access. However, vulnerabilities in the MLM can allow unauthorized access to the provided digital content and thereby allow for unauthorized copying and manipulation of that content.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that supports security for an MLM via decryption and re-encryption of the MLM in accordance with some implementations.

FIG. 2 is a block diagram illustrating an example of the processing system of FIG. 1 decrypting and re-encrypting a received MLM in accordance with some implementations.

FIG. 3 is a block diagram illustrating an example of the processing system of FIG. 1 receiving an encrypted MLM and non-encrypted parameters of the MLM in accordance with some implementations.

FIG. 4 is a flow diagram illustrating a method of preventing unauthorized access to an MLM in accordance with some implementations.

FIG. 5 is a block diagram illustrating an example of the processing system of FIG. 1 protecting access to a buffer of a neural processing unit (NPU) in accordance with some implementations.

FIG. 6 is a flow diagram of a method of protecting access to a buffer of an NPU in accordance with some implementations.

### DETAILED DESCRIPTION

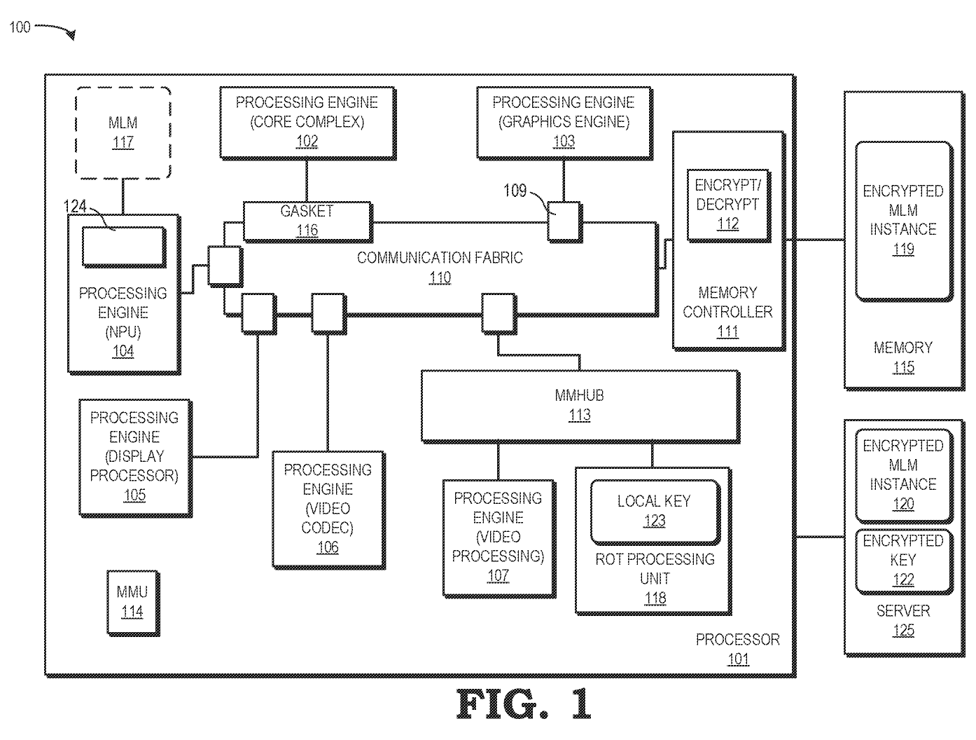

FIGS. 1-6 illustrate techniques for protecting a machine learning model (MLM) from unauthorized access at a processing system. The processing system employs a neural processing unit (NPU) to execute the MLM, and implements decryption and encryption processes to decrypt the MLM and re-encrypt the MLM at different points along MLM storage and execution paths. Furthermore, the processing system executes the encryption and decryption processes at different processing units and processing engines, thereby reducing the ability of malicious software to access the MLM. In addition, the processing system protects buffers of the NPU from unauthorized access.

To illustrate via an example, in some implementations the processing system includes an neural processing unit configured to execute the MLM, a root-of-trust (RoT) processing unit to perform security operations for the processing system, a processing engine (e.g., a codec) to perform specified processing operations, and a memory controller having encryption/decryption hardware. The processing system receives an encrypted instance of the MLM from an external server, along with an encrypted key. The RoT processing unit authenticates the MLM (e.g., based on a received certificate) and, if the MLM is authenticated, decrypts the key. The processing engine decrypts the encrypted MLM instance, and the memory controller re-encrypts the MLM with a different key provided by the RoT processing unit. The re-encrypted instance of the MLM is stored at a memory of the processing system. To execute the MLM, the processing system retrieves the encrypted MLM instance from the memory, decrypts the retrieved MLM instance at the memory controller, and executes the decrypted MLM instance at the neural processing unit. The processing system thus supports end-to-end encryption of the MLM, thereby protecting the MLM from unauthorized access and modification.

In addition, the processing system protects buffers of an NPU from unauthorized access. To illustrate via an example, in some implementations the NPU executes the MLM to generate inferences on behalf of a central processing unit (CPU). The processing system generally protects data from unauthorized access by assigning different keyspaces to the different processing engines, with each keyspace assigned a different corresponding key, and using hardware to ensure that data generated with a particular keyspace is not permitted to exit the keyspace. However, in order to make use of the generated inferences, it is useful for the CPU to access the data generated by the NPU. Accordingly, it is desirable to expose at least some of the data generated by the NPU to the CPU—that is, to transfer the data out of the NPU’s keyspace. Conventionally, the data is exposed by making one or more NPU buffers readable by the CPU, and the CPU reads the data at a buffer by generating a read request with a virtual address (VA) that targets the buffer. However, this approach allows a malicious hypervisor or memory manager to change the VA to point to a protected data buffer at the NPU, thereby obtaining unauthorized access to data at the NPU (e.g., data generated for a processing engine other than the CPU, or data generated for a protected virtual machine).

To address this vulnerability, described herein are techniques wherein when a buffer of the NPU is allocated, a memory manager of the processing system generates the VA for the register so that a portion of the VA includes a key ID, indicating the type of buffer allocated. For example, the portion of the VA indicates whether the buffer is an input buffer, an output buffer within the keyspace of the NPU, or an output buffer to provide data outside of the NPU keyspace. When the NPU receives a request to access an output buffer, the NPU compares the specified portion of the received virtual address with the key ID assigned to the buffer. In response to a mismatch, the NPU prevents access to the buffer. Thus, when the CPU makes an authorized request to access a buffer, the memory manager generates a VA for the request and includes the correct key ID for the buffer. In contrast, when a malicious hypervisor generates a request to access a buffer of the NPU, the firmware of the NPU ensures that only the assigned key ID for the correct buffer type is used. The request generated by the malicious hypervisor is therefore denied by the NPU, protecting data at the NPU from unauthorized access. The processing system thereby allows data to be transferred from the NPU to a CPU or other processing engine outside of the NPU’s keyspace, while protecting the data at the NPU from being accessed by a malicious entity.

FIG. 1 illustrates a block diagram of a processing system 100 that is generally configured to present digital data to a user in accordance with some implementations. Examples of the digital data include image data, audio data, and the like or any combination thereof. Thus, in different implementations, the digital data includes game data, video data (e.g., movies and television), audio data (e.g., music), and the like, or any combination thereof. Accordingly, in different implementations, the processing system 100 is implemented, or partially implemented, in an electronic device configured to present digital data to a user, such as desktop computer, laptop computer, game console, smartphone, television, automobile, and the like.

To support presentation of digital content, the processing system 100 includes a processor 101 and a memory 115. It will be appreciated that, at least in some implementations, the processing system 100 includes additional circuitry, not illustrated at FIG. 1, that supports presentation of digital data, such as one or more display devices, one or more input/output devices and associated controllers, one or more network interfaces, one or more power sources and associated circuitry, and the like, or any combination thereof. Turning to the circuitry illustrated at FIG. 1, the memory 115 is a set of one or more memory devices generally configured to store data on behalf of the processor 101. Thus, in the course of performing one or more aspects of the operations described herein, the processor 101 generates memory operations that store data at the memory 115 (e.g., write operations), retrieve data from the memory 115 (e.g., read operations), or a combination thereof. Accordingly, in different implementations the memory 115 includes random access memory (RAM), non-volatile memory (e.g., flash memory), storage devices such as hard disc drives and solid-state disc drives, and the like, or any combination thereof. It will be appreciated that in some implementations the processing system 100 includes additional memory not shown at FIG. 1, such as one or more caches, buffers, registers, and the like, and associated control circuitry.

The processing system 100 further includes a processor 101 generally configured to carry out processing operations, including one or more of general-purpose processing operations (e.g., execution of an operating system and application software), graphics processing operations, audio processing operations, display processing operations, machine learning and neural network operations, data security operations, and the like, or any combination thereof. To support execution of these operations, the processor 101 includes a plurality of processing engines, designated processing engines 102-107. Each of the processing engines 102-107 is generally configured to carry out processing operations of a designated type, or set of types, independently of the other processing engines. This allows the processor 101 to carry out multiple tasks at the different processing engines in parallel, thus improving processing efficiency.

To illustrate, in the example of FIG. 1 the processor 101 is assumed to be a multimedia processor generally configured to execute multimedia operations, including processing and presentation of audio data, image data, video data, and the like. Accordingly, each of the processing engines 102-107 is generally configured to carry out operations associated with one or more multimedia tasks. Thus, for the example of processing system 100, the processing engine 102 is a core complex including one or more processor cores that collectively form one or more central processing units (CPUs). The one or more CPUs are configured to execute (e.g., via one or more instruction pipelines) general-purpose processing tasks, such as execution of an operating system, user interface programs, productivity applications, and the like. The processing engine 103 is a graphics engine including one or more graphics processing units (GPUs) generally configured to execute graphics operations, such as draw operations, raytracing operations, image frame generation operations, and the like, or any combination thereof.

The NPU 104 is an inference processing unit (IPU), also referred to as a neural processing unit (NPU), generally configured to execute machine learning operations, such as execution of operations associated with one or more machine learning models (MLMs), including an MLM 117. Thus, in some implementations the NPU is configured to execute the operations associated with different layers of the MLM 117, including application of input data to an initial layer of the MLM 117, performing the calculations (e.g., matrix multiplications) for each layer of the MLM 117 and based on the weights assigned to each layer, and generation of an output of the MLM 117 at a final layer.

The processing engine 105 is a processing engine generally configured to execute display operations, including processing of pixel data and providing the pixel data to one or more display devices (not shown) to display. Examples of such display operations include one or more of color space conversion, linearization of pixel data, tone mapping, gamut mapping, plan blending, pixel formatting, display writeback, and the like, or any combination thereof. The processing engine 106 is a video codec processing engine and is generally configured to perform operations associated with one or more specified video codecs. Thus, for example, the processing engine 106 is configured to execute compression operations for video or audio data, decompression operations for video or audio data, and the like, or any combination thereof. The processing engine 107 is a video processing engine configured to execute video processing operations. Thus, for example, in some implementations the processing engine 107 executes decoding operations, de-interlacing operations, gamma correction operations, scaling, filtering, and sharpening operations, encoding operations, quantization operations, discrete cosine transformation (DCT) and inverse DCT operations, motion compensation operations, blending operations, dithering operations, and the like, or any combination thereof.

It will be appreciated that the above-described processing engines are examples only, and that the techniques described herein apply to processors and processing systems having additional, fewer, or different processing engines than those illustrated in the example of FIG. 1. Further, although the different processing engines 102-107, and other circuits, are illustrated as being incorporated in a single processor 101, in other implementations one or more of the processing engines is incorporated in a different processor, different integrated circuit, different chiplet, and the like, or any combination thereof.

The processing engines 102-107 are configured to communicate with each other via a communication fabric 110. In different implementations, the communication fabric 110 is any fabric, or combination of fabrics, configured to route messages between different fabric ports. Thus, in different implementations, the communication fabric is a Peripheral Component Interconnect Express (PCIe) fabric, an Infinity Fabric (IF), or other communication fabric. In operation, the processing engines 102-107 communicate with each other via messages referred to herein as transactions. Each transaction includes a request (e.g., a command) for a processing engine to perform one or more operations, results of operations executed by a processing engine, and the like, or any combination thereof. For example, in some implementations, the processing engine 102 (the core complex) executes an application program. In the course of execution, the application generates one or more draw commands, and the processing engine 102 sends the draw commands, via one or more transactions, to the processing engine 103 (the graphics engine). The processing engine 103 executes the draw commands and provides the results of the draw operations, via one or more transactions, to, for example, the processing engine 105 (the display processor). In response, the processing engine 105 displays one or more frames for display at a display device.

The processor 101 further includes a memory controller 111 to support interaction with the memory 115 by the processing engines 102-107. In particular, the memory controller 111 includes circuits to receive memory access requests from the processing engines 102-107 via the communication fabric 110, and to translate those memory access requests into control signaling. The memory controller 111 provides the control signaling to the memory 115 in order to carry out the memory access requests, and provides any responsive information (e.g., data read from the memory 115) to the processing engine that issued the memory access request.

In addition, the processor 101 includes a multimedia hub (MMHUB) 113 generally configured to manage multimedia and other operations for connected processing engines, such as the processing engine 107. Thus, for example, in some implementations the MMHUB 113 aggregates transactions received from, and targeted to, the connected processing engines and other processors, and manages provision of those transactions to their targeted destinations. Accordingly, the MMHUB 113 includes circuits to perform aggregation operations such as transaction buffering, transaction flow management (e.g., backpressure, transaction priority management, and other management operations), and the like, or any combination thereof.

In some implementations, the processor 101 is generally configured to store and process sensitive data—that is, data that is to be protected from unauthorized access. To support data security, the processor 101 includes a root-of-trust (RoT) processing unit 118. The RoT processing unit 118 is a processing unit that is isolated from access by the processing engines 102-107 and is generally configured to perform security operations for the processor 101. Examples of such security operations, in different implementations, include: reception of cryptographic keys from a server (not shown) via a network, decryption of encrypted keys, provision of cryptographic keys (e.g., local key 123) to one or more of the processing engines 102-107 and the memory controller 111, management of a secure boot process for the processor 101, setting of security policies at the processor 101, handling of security interrupts at the processor 101, authentication and loading of firmware at the processing engines 102-107, managing software and hardware trust levels at the processor 101, and the like, or any combination thereof.

In some implementations, the RoT processing unit 118 is configured to provision and manage security spaces, referred to as keyspaces, for the processor 101. Each keyspace corresponds to one or more security aspects of the processor 101, and the RoT processing unit 118 is configured to assign entities to the keyspaces, wherein the entities include one or more of the processing engines 102-107, one or more executing programs (e.g., one or more virtual machines), one or more DRM channels, and the like, or any combination thereof. The security aspects of a keyspace, in different implementations, include one or more of a cryptographic key (e.g., local key 123), permission levels (e.g., permission to access a DRM channel), read privileges (e.g., permission to read data), write privileges (e.g., permission to write data), and the like, or any combination thereof. Furthermore, each of the keyspaces is configurable by the RoT processing unit 118, allowing the processing unit 118 to configure the different keyspaces differently for different processing systems and processing system applications. Furthermore, in some implementations, at least some of the keyspaces are managed, or managed in part, by an operating system executing at the processing engine 102, by a hypervisor (not shown), or a combination thereof.

To illustrate, in some implementations the processor 101 employs keyspaces to govern access to different encrypted memory spaces (not shown) at the memory 115. The RoT processing unit 118 provisions (e.g., from a trusted server) a different cryptographic key to each of two keyspaces and assigns each keyspace to a different one of the encrypted memory spaces. The RoT processing unit 118, an operating system, or a hypervisor, assigns each keyspace to a different program (e.g., a different virtual machine) executing at the processing engine 102. The memory controller 111 includes encryption/decryption circuit 112 that encrypts encrypt and decrypt data based on a cryptographic key. The RoT processing unit 118 provides the cryptographic key for each keyspace to the encryption/decryption circuit 112 at the memory controller 111. When a program executing at the processing engine 102 generates a memory transaction (e.g., a read or write operation) targeting an encrypted memory space, the program provides with the memory transaction (e.g., via a memory address) a keyspace identifier. The encryption/decryption circuit 112 uses the keyspace identifier to identify a provided cryptographic key and uses the key to encrypt (for a write operation) or decrypt (for a read operation) the corresponding data. The processor 101 thus allows different programs executing at the processing engine 102 to employ protected (trusted) memory spaces to store sensitive data and thereby protect the data from unauthorized access.

In some implementations, the processor 101 employs keyspaces and a set of hardware gaskets (e.g., gaskets 109 and 116) to establish and enforce a set of hardware-isolated DRM channels. Each of the gaskets governs access to an ingress port of the communication fabric 110 for a corresponding one of the processing engines 102-107. Thus, for example, the gasket 116 governs access to the communication fabric 110 by the processing engine 102, while the gasket 109 governs access to the communication fabric 110 by the processing engine 103. It will be appreciated that in the illustrated example of FIG. 1, the gaskets are located at the communication fabric 110 itself (e.g., as part of the circuitry for each ingress port). However, in other implementations the gaskets are located, for example, at each of the processing engines 102-107, at one or more hubs of the processor 101 (e.g. at the MMHUB 113), and the like.

In some implementations, the processor 101 supports security features to provide end-to-end security (that is, security between reception and execution) for an MLM 117. In particular, the processor 101 provides encryption and decryption hardware to encrypt and decrypt different instances of the MLM 117 at different points along a storage and execution path for the MLM 117, thereby preventing unauthorized access to MLM aspects such as weights, model graphs, and kernel images. As used herein, an instance of an MLM, such as an instance of the MLM 117, refers to a version of the MLM 117 in a specified encrypted or decrypted (that is, non-encrypted) state. For example, an encrypted MLM instance (e.g., encrypted MLM instance 119) refers to an encrypted version of the MLM 117. It will be appreciated that, as described further herein, different encrypted instances of the MLM 117 are sometimes encrypted based on different keys.

In operation, a server 125 provides an encrypted MLM instance 120 (that is an encrypted instance of the MLM 117) to the processor 101, along with an encrypted key 122. The encrypted MLM instance 120 has previously been encrypted with a decrypted instances of the encrypted key 122. In some implementations, the RoT processing unit 118 first authenticates the encrypted MLM instance 120 based on a received security certificate (not shown). In some implementations, the security certificate is provided to the processor 101 by the server 125, or by a different server. If the RoT processing unit 118 determines that the encrypted MLM instance 120 is authentic, the RoT processing unit 118 decrypts the encrypted key 122 and provides the decrypted key to the processing engine 106.

The processing engine 106 decrypts the encrypted MLM instance 120 with the decrypted key and provides the resulting decrypted MLM instance to the memory controller 111. In response, the memory controller 111 re-encrypts the decrypted MLM instance based on the local key 123, provided by the RoT processing unit 118. The memory controller 111 thereby generates an encrypted MLM instance 119, and stores it at the memory 115. In some implementations, the local key 123 is a different key than the encrypted key 122 (that is, is different than the decrypted version of the encrypted key 122). In some implementations, the RoT processing unit 118 generates the local key 123 based on an Advanced Encryption Standard (AES) process. In other implementations, an external server or other device generates the local key 123 and provides the local key 123 to the RoT processing unit for storage and subsequent provision to the memory controller 111.

In response to a request to execute the MLM 117, the NPU 104 (that is, the neural processing unit) sends a load operation to the memory controller 111. In response, the memory controller 111 retrieves the encrypted MLM instance 119 from the memory 115, decrypts the encrypted MLM instance 119 (using the encryption/decryption circuit 112), and provides the resulting decrypted MLM instance to the NPU 104 via the communication fabric 110. The NPU 104 then executes the decrypted instance of the MLM 117. Thus, the processing system 100 maintains an encrypted instance of the MLM 117 (that is, the encrypted MLM instance 119), and decrypts the instance only when the MLM 117 is to be executed by the neural processing unit. Furthermore, the encrypted MLM instance 119 is encrypted with a key known only to the RoT processing unit 118. The encrypted MLM instance is 119 is therefore not accessible, in a decrypted form, by programs executing at any of the processing engines 102, 103, and 105-107. Thus, the MLM 117 is protected from unauthorized access and modification, providing enhanced security both for the MLM 117 itself, and for DRM content being presented by the processing system 100.

In some implementations, the processing system 100 employs keyspaces, and key IDs, to allow transfer of data generated by the NPU 104 outside of the keyspace for the NPU 104, while protecting data at the NPU 104 from unauthorized access. To illustrate, in some implementations the NPU 104 includes a plurality of buffers, such as buffer 124. The buffers of the NPU 104 allow data to be transferred to and from the NPU 104, allowing the NPU 104 to receive input data from another processing engine, generate inference data by executing the MLM 117 based on the input data, and provide the input data to another processing engine. To facilitate this data transfer, the NPU 104 is configured to allocate each of the plurality of buffers to have a specified buffer type, wherein the buffer type indicates the hardware-enforced behavior of the buffer. Thus, for example, in some implementations, some buffers are allocated as input buffers for data from outside the keyspace of the NPU 104, some buffers are allocated as input buffers for data within the keyspace of the NPU 104, some buffers are allocated as weight or intermediate buffers for execution of the MLM 117, some buffers are allocated as output buffers within the keyspace of the NPU 104, and some buffers are allocated as output buffers outside the keyspace of the NPU 104 (that is, output buffers that are to be accessed by processing engines outside of the keyspace of the NPU 104).

Each of the buffers of the NPU 104 is assigned a virtual address by a memory management unit (MMU) 114 of the processor 101. In particular, when the NPU 104 allocates a buffer, it requests a virtual address from the MMU 114 and indicates the type of buffer to be allocated. The MMU 114 generates, according to a specified address generation scheme for the processor 101, a virtual address for the allocated buffer. The MMU 114 is configured to generate the virtual address so that a specified portion of the virtual address (e.g., the first N bits of the virtual address, where N is an integer) indicate the type of the buffer. This specified portion is referred to herein as the buffer type identifier, or buffer type ID, for the buffer. That is, the MMU 114 generates the virtual address for an allocated buffer to include a buffer type ID that indicates whether the buffer is an input buffer within the keyspace of the NPU 104, an input buffer for data outside the keyspace of the NPU 104, a weight or intermediate buffer, an output buffer for data within the keyspace of the NPU 104, and an output buffer for data outside the keyspace of the NPU 104.

In the course of executing operations, the NPU 104 receives requests to access data at the different buffers, wherein the requests are sometimes generated internally, or are received from another processing engine. Each request includes a virtual address targeting the buffer being accessed. In response to receiving a request to access a buffer, the NPU 104 determines if the virtual address of the request includes a buffer type ID that matches the buffer type ID for the virtual address generated by the MMU 114. In response to a match, the NPU 104 allows access to the buffer. In response to a mismatch in the buffer ID type, the NPU 104 denies access to the buffer. The NPU 104 thereby allows access to specific buffers that provide data outside the keyspace of the NPU 104, while protecting the data that is to be maintained within the keyspace. In some implementations, the allocation of buffers (and requests to allocate the buffers) of the NPU 104 and the setting of the virtual addresses within a keyspace is managed by privileged software (e.g., software that has been authenticated at the processing system 100 via a specified authorization process, such as a public-private key authentication process). In some implementations, processing of data withing a keyspace is managed by software having a higher privilege level.

To illustrate via an example, in some implementations the processing engine 102 is a CPU that executes one or more virtual machines (VMs), and in some cases a VM requests that the MLM 117 generate an inference. It is assumed that the processing engine 102 is outside the keyspace of the NPU 104. In response to the request to generate an inference, the processing engine 102 requests an input buffer and an output buffer at the NPU 104. In response, the MLM 117 allocates the two requested buffers, and generates VAs for each buffer, such that each VA includes a buffer type ID indicating the type of the associated buffer. The processing engine 102 generates one or more write requests to store input data at the allocated input buffer. The NPU 104 executes the MLM 117 to generate the inference and stores the corresponding inference data at the allocated output buffer. The processing engine 102 generates one or more read requests to read the data at the output buffer, wherein each read request includes the VA for the output buffer. For each received read request, the NPU 104 compares the buffer type ID of the received VA to the buffer type ID of the buffer. In response to a mismatch, the NPU 104 does not fulfill the request, thereby protecting the inference data, or other data at the NPU 104, from unauthorized access. In response to a match in the buffer ID type, the NPU 104 satisfies the request, thereby transferring data out of the keyspace for the NPU 104.

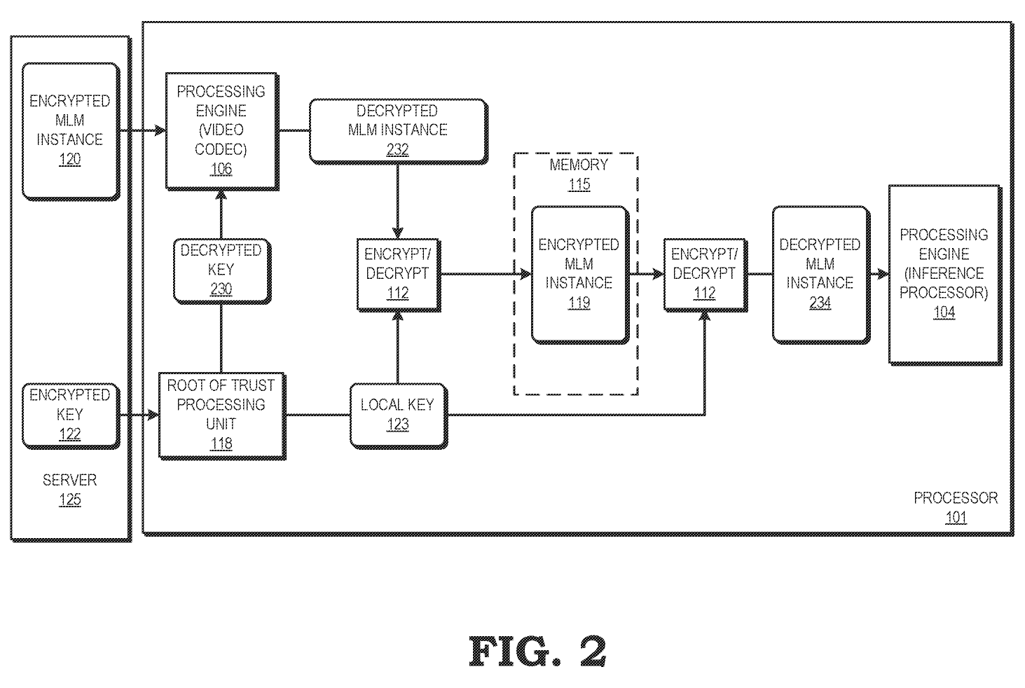

FIG. 2 illustrates an example of the processing system 100 encrypting and decrypting the MLM 117 at different points along a storage and execution path in accordance with some implementations. In the depicted example, the server 125 provides both the encrypted MLM instance 120 and the encrypted key 122 to the processor 101. In some implementations, the encrypted MLM instance 120 is an encrypted pre-compiled version of the MLM 117. A model provider has previously generated the encrypted MLM instance 120 by encrypting the MLM 117 with a model provider encryption key (that is, an encryption key owned or assigned to the model provider). In addition, the model provider has generated the encrypted key 122 by encrypting the model provider encryption key with a public key assigned to the processor 101.

In some implementations, the server 125 (or other server) also provides a security certificate (not shown) to the processor 101. The RoT processing unit 118 uses the provided certificate to execute a specified verification process to determine whether the MLM 117 is certified to be executed at the processor 101. If the MLM 117 is not certified, the RoT processing unit 118 does not decrypt the encrypted key 122. The encrypted MLM instance 120 is therefore not decrypted, and the MLM 117 is not executed by the processor 101.

If the MLM 117 is certified, the RoT processing unit 118 then decrypts the encrypted key 122, based on a private key assigned to the processor 101 and stored at the RoT processing unit 118. The private key is unknown to and inaccessible by the processing engines 102-107, such that the encrypted key 122 can only be decrypted by the RoT processing unit 118. Decryption of the encrypted key 122 results in a decrypted key 230.

The RoT processing unit 118 provides the decrypted key 230 to the processing engine 106. In response, the processing engine 106 decrypts the encrypted MLM instance 120 with the decrypted key 230, thereby generating a decrypted MLM instance 232. The processing engine 106 provides the decrypted MLM instance 232 to the memory controller 111. In response, the memory controller 111 employs the encryption/decryption circuit 112 to re-encrypt the decrypted MLM instance 232, based on the local key 123. The memory controller 111 thereby generates the encrypted MLM instance 119 and stores it at the memory 115.

In response to a request from the NPU 104 (the neural processing unit) to load the MLM 117, the memory controller 111 retrieves the encrypted MLM instance 119 from the memory 115. The memory controller 111 employs the encryption/decryption circuit 112 to decrypt the encrypted MLM instance 119 based on the local key 123. The encryption/decryption circuit 112 thereby generates a decrypted MLM instance 234. The memory controller 115 provides the decrypted MLM instance 234 to the NPU 104. The NPU 104 uses the decrypted MLM instance 234 to execute the MLM 117. Thus, in the example of FIG. 2, the processing system 100 employs different encryption keys to decrypt a received instance of the MLM 117 and to re-encrypt the MLM 117 with a local key (local key 123). Furthermore, the processor 101 employs different hardware (the processing engine 106 and the encryption/decryption circuit 112) to decrypt and re-encrypt the MLM 117, thereby further protecting the MLM from unauthorized access and modification.

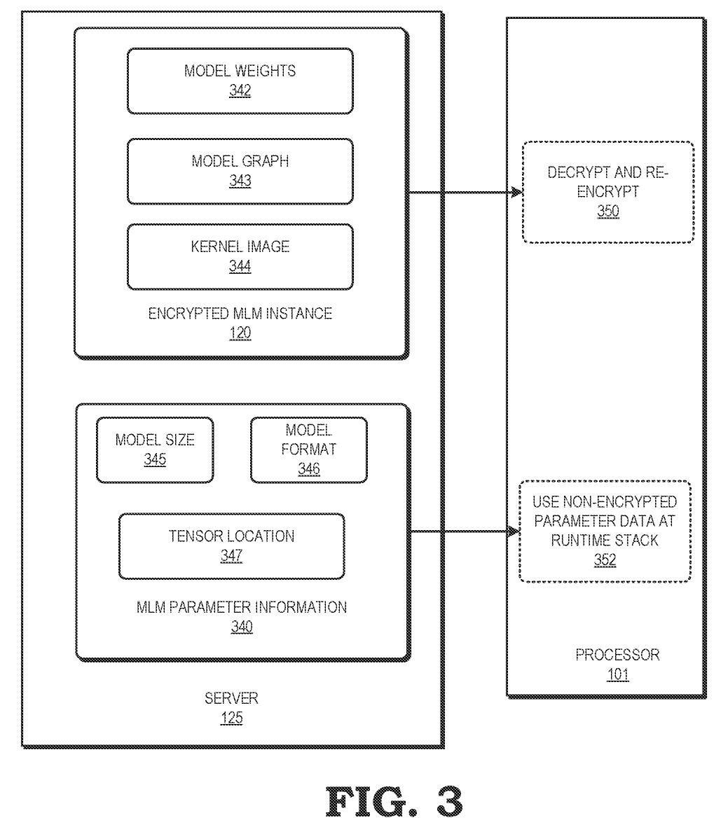

In some implementations, the NPU 104 employs MLM parameter information (e.g., model size information) to execute the MLM 117. This MLM parameter information does not typically allow access to, or modification of, aspects of the MLM 117 itself. For example, access to the model size information does not allow an entity to modify the weights or model graph of the MLM 117. Accordingly, to improve processing efficiency, in some implementations the NPU 104 executes the MLM 117 based on non-encrypted (e.g., plaintext) MLM parameter information. An example is illustrated at FIG. 3 in accordance with some implementations.

In the example of FIG. 3, the server 125 stores the encrypted MLM instance 120, which includes model weights 342, a model graph 343, and a kernel image 344. The model weights 342 include model weight information for the MLM 117, such as weight values, weight scale, weight bias, and the like, or any combination thereof. The model graph 343 includes information reflecting the topology of the MLM 117, such as tensor shape information, layer attributes, other layer information, and the like, or any combination thereof. The kernel image 344 includes kernel information for execution of the MLM 117 at the NPU 104.

The server 125 also includes MLM parameter information 340 for the MLM 117, including model size information 345, model format information 346, and tensor location information 347. The model size information 345 includes information indicating the size of the MLM 117, such as a number of parameters, number of inputs, number of outputs, and the like, or any combination thereof. The model format information 346 includes information indicating formats associated with the MLM 117, such as input format and output format for the MLM 117. The tensor location information 347 reflects tensor location information, such as input and output tensor information, for the MLM 117.

It is assumed for the example of FIG. 3 that the information stored by the encrypted MLM instance 120 is information that could be modified to modify the underlying behavior of the MLM 117, and thereby allow the MLM 117 to, for example, access DRM data in an unauthorized fashion. Accordingly, the information stored by the encrypted MLM instance 120 is subject to encryption, decryption, and re-encryption, as described herein, and as noted by block 350 of FIG. 3. In contrast, the MLM parameter information 340, if accessed or modified, is assumed not to modify the underlying behavior of the MLM 117 such that the MLM 117 could be used for malicious applications. Accordingly, the MLM parameter information 340 is not encrypted, and is not decrypted or re-encrypted at the processor 101. Instead, as shown at block 352, the MLM parameter information 340 is employed directly, in non-encrypted form, at a runtime stack of the NPU 104 (the neural processing unit). This reduces the overall overhead associated with executing the MLM 117 at the processor 101.

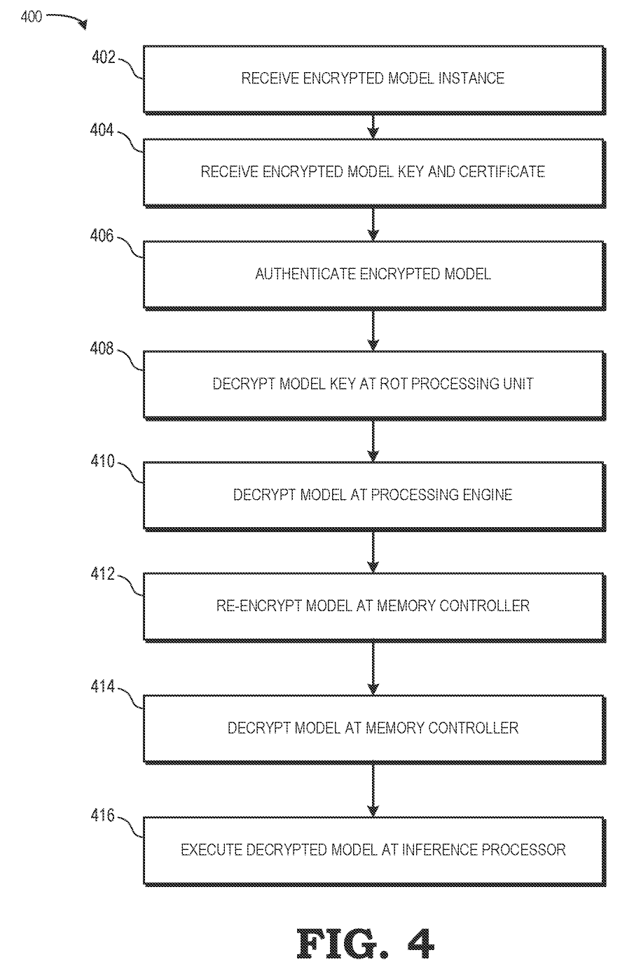

FIG. 4 illustrates a flow diagram of a method 400 of providing end-to-end security for an MLM at a processing system in accordance with some implementations. For purposes of description, the method 400 is described with respect to an example implementation at the processing system 100 in accordance with some implementations. However, it will be appreciated that in other implementations, the method 400 is implemented at processing systems having a different configuration.

At block 402, the processor 101 receives the encrypted model instance 120 from the server 125. In some implementations, the server 125 is owned or operated by a model provider, and the encrypted model instance is a pre-compiled instance of the MLM 117. In addition, at block 404, the server 125 provides to the processor 101 the encrypted key 122 and an authentication certificate. In at least some implementations, the processor 101 receives the encrypted model instance 120 and the encrypted key 122 via a wide area network, such as the Internet.

At block 406, the RoT processing unit 118 uses the received certificate to authenticate the encrypted model instance 120. For example, the RoT processing unit determines if the received certificate has been issued by a trusted entity, if the certificate is valid (e.g., based on the date the certificate was issued), whether the certificate has been revoked, and the like. If the RoT processing unit 118 determines that the certificate is not authentic, the processor 101 does not proceed with the method 400.

If the RoT processing unit 118 determines that the certificate is authentic, the method flow moves to block 408 and the RoT processing unit 118 decrypts the encrypted key 122. For example, in some implementations the RoT processing unit 118 stores a private key corresponding to a public encryption key, wherein the encrypted key 122 has previously been encrypted with the public key. The private key is stored at the RoT processing unit 118 during, for example, a provision or configuration stage of development of the processor 101. The RoT processing unit 118 decrypts the encrypted key 122 using the private key and thereby generates the decrypted key 230.

At block 410, the processing engine 106 uses the decrypted key 230 to decrypt the encrypted MLM instance 120. The processing engine 106 thereby generates the decrypted MLM instance 232. At block 412, the encryption/decryption circuit 112 re-encrypts the decrypted MLM instance 232 based on the local key 123, thus generating the encrypted MLM instance 119. The memory controller 111 stores the encrypted MLM instance 119 at the memory 115.

At block 414, in response to a request from the NPU 104 (the neural processing unit) to load the MLM 117, the memory controller 111 retrieves the encrypted MLM instance 119 from the memory 115. The encryption/decryption circuit 112 decrypts the encrypted MLM instance 119 using the local key 123, thereby generating the decrypted MLM instance 234. At block 416, the NPU 104 uses the decrypted MLM instance 234 to execute the MLM 117.

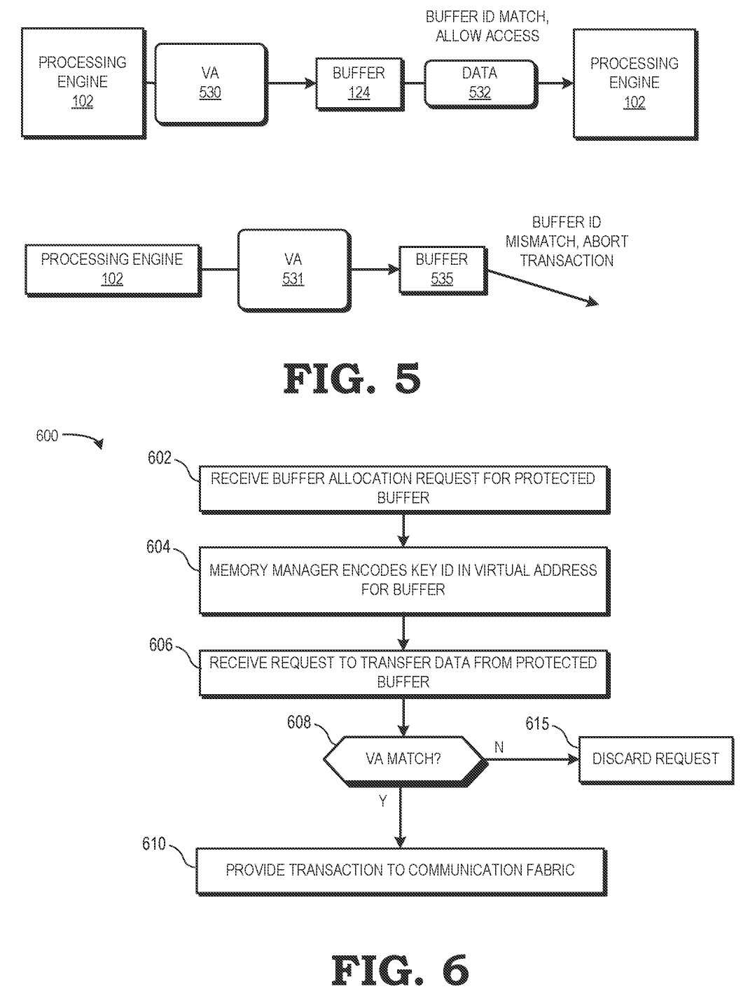

FIG. 5 illustrates an example of the processing system 100 protecting data at the NPU 104 from unauthorized access in accordance with some implementations. In the illustrated example, at a first time the processing engine 102 generates a read request to read data from the buffer 124. The read request includes a virtual address (VA) 530. In response to receiving the read request, the NPU 104 compares the buffer type ID of the VA 530 to the buffer type ID of the buffer 124 and determines that the buffer type IDs match. In response, the NPU 104 provides the data at the buffer 124 (designated data 532) to the processing engine 102.

Subsequently, the processing engine 102 generates another read request to access data at a different buffer, designated buffer 535, of the NPU 104. The read request includes a virtual address 531. The NPU 104 compares the buffer type ID indicated by the virtual address 531 to the buffer type ID of the buffer 535 and determines a mismatch. In response, the NPU 104 discards the transaction, thereby preventing unauthorized access to data stored at the buffer 535. In some implementations, the NPU 104 takes other remedial actions, such as by sending an error message to the RoT processing unit 118.

FIG. 6 illustrates a flow diagram of a method 600 of protecting data at neural processing unit from unauthorized access. The method 600 is described with respect to an example implementation at the processing system 100 of FIG. 1, but it will be appreciated that in other implementations the method 600 is implemented at a processing system having a different configuration. At block 602, the NPU 104 receives a request to allocate a buffer, such as buffer 124, to be a buffer of a particular type, such as an output buffer for data to be transferred out of a keyspace assigned to the NPU 104. In response, at block 604 the MMU 114 generates a virtual address for the buffer and encodes the buffer type ID for the requested buffer type at a specified portion of the virtual address (e.g., the first N bits of the virtual address, where N is an integer).

At block 606, the NPU 104 receives a request (e.g., from the processing engine 102) to access the allocated buffer. The request includes a virtual address for the targeted buffer. In response, at block 608 the NPU 104 determines whether the buffer type ID of the received virtual address matches the buffer type ID allocated to the buffer. In response to a match, the method flow moves to block 610 and the NPU 104 allows access to the data at the buffer (e.g., transfers the data to the processing engine that generated the request). In response to a mismatch in the buffer type IDs, the method flow moves to block 615 and the NPU 104 discards the request, thereby preventing access to the data stored at the buffer. The processing system 100 thus protects data from unauthorized access while allowing data to be transferred out of the keyspace assigned to the NPU 104.

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method comprising:
encrypting a machine learning model (MLM) [117] at a processor [101] to generate a first encrypted instance of the MLM [119], the encrypting based on a first encryption key [123] assigned to a neural processing unit [104] (NPU) of the processor;
storing the first encrypted instance of the MLM at a memory [115];
decrypting the MLM from the memory to generate a first decrypted instance of the MLM; and
executing the first decrypted instance of the MLM at the NPU.

2. The method of claim 1, further comprising:
receiving a second encrypted instance [120] of the MLM at the processor, the second encrypted instance based on a second encryption key [122]; and
decrypting the second encrypted instance of the MLM to generate a second decrypted instance of the MLM [232]; and
wherein encrypting the MLM at the processor comprises encrypting the second decrypted instance of the MLM.

3. The method of claim 2, wherein decrypting the second encrypted instance comprises decrypting the second encrypted instance at a second processing unit [106] different from the NPU.

4. The method of claim 3, further comprising:
receiving an encrypted instance of the second encryption key at the processor; and
decrypting the encrypted instance of the second encryption key to decrypt the second encrypted instance of the MLM.

5. The method of claim 4, wherein decrypting the encrypted instance of the second encryption key comprises decrypting the encrypted instance of the second encryption key at a root-of-trust processing unit [118] of the processor, different from the NPU.

6. The method of claim 2, wherein the second encrypted instance includes model weights [342] of the MLM.

7. The method of claim 2, wherein the second encrypted instance includes model graph characteristics [343] of the MLM.

8. The method of claim 2, further comprising:
receiving, at the NPU, unencrypted parameter information [340] associated with the MLM; and
wherein executing the MLM comprises executing the MLM based on the unencrypted parameter information.

9. A method, comprising:
receiving, at a processor, a request to access a buffer [124] of a neural processing unit [104]; and
preventing, in response to the request, access to the buffer based on a buffer type assigned to the buffer.

10. The method of claim 9, wherein :
the buffer type is based on a first virtual address [530] assigned to the buffer.

11. The method of claim 10, wherein preventing access to the buffer comprises:
comparing a portion of a second virtual address associated with the request to the first virtual address assigned to the buffer; and
preventing access to the buffer based on the comparing.

12. The method of claim 11, further comprising:
in response to a request to allocate the buffer, generating the first virtual address to include an indicator of the buffer type at a memory management unit of the processor.

13. The method of claim 9, wherein:
the buffer type is one of an input buffer, an output buffer assigned to a first keyspace of the NPU, and an output buffer assigned to a second keyspace different from the first keyspace..

14. A processor [100], comprising:
a neural processing unit (NPU) [104];
an encryption circuit [112] configured to encrypt a machine learning model (MLM) [119] at a processor to generate a first encrypted instance of the MLM, the encrypting based on a first encryption key assigned to the NPU;
a memory controller [111] configured to store the encrypted MLM at a memory [115]; and
a decryption circuit [112] configured to decrypt the MLM from the memory to generate a first decrypted instance of the MLM.

15. The processor of claim 14, wherein the processor is configured to:
receive a second encrypted instance [120] of the MLM at the processor, the second encrypted instance based on a second encryption key [122]; and
decrypt the second encrypted instance of the MLM to generate a second decrypted instance of the MLM [232]; and
wherein encrypting the MLM at the processor comprises encrypting the second decrypted instance of the MLM.

16. The processor of claim 15, further comprising:
a second processing unit [106] configured to decrypt the second encrypted instance, the second processing unit different from the NPU.

17. The processor of claim 16, wherein the processor is configured to:
receive an encrypted instance of the second encryption key at the processor; and
decrypt the encrypted instance of the second encryption key to decrypt the second encrypted instance of the MLM.

18. The processor of claim 17, further comprising:
a root-of-trust processing unit [118] configured to decrypt the encrypted instance of the second encryption key, the root-of-trust processing unit different from the NPU.

19. The processor of claim 15, wherein the second encrypted instance includes model weights [342] of the MLM.

20. The processor of claim 15, wherein the second encrypted instance includes model graph characteristics [343] of the MLM.
